(19) United States
(12) Patent Application Publication
(10) Pub. No.: US 2017/0004126 A1
(43) Pub. Date: Jan. 5, 2017

(54) INFORMATION DISPLAY METHOD AND DEVICE

(71) Applicant: Alibaba Group Holding Limited, George Town (KY)

(72) Inventors: Lihong LI, Hangzhou (CN); Rui JIN, Hangzhou (CN); Wenhan BIAN, Hangzhou (CN)

(21) Appl. No.: 15/196,986

(22) Filed: Jun. 29, 2016

(30) Foreign Application Priority Data
Jun. 30, 2015 (CN) 201510374912.X

(51) Int. Cl. G06F 17/24; G06F 17/30; G06Q 30/06; G06F 17/21; G06F 3/0482

(52) U.S. Cl. CPC G06F 17/248; G06F 17/212; G06F 3/0482; G06Q 30/0641; G06Q 30/0633; G06F 17/30864

(57) ABSTRACT

Embodiments of the present invention disclosed herein include an information display method and device, wherein the method comprises using a terminal device to acquire a user's event information. Based on the acquired event information, the terminal device selects a matching visual template for the event information. The terminal device selects a corresponding visual template after acquiring the user's event information, and displays the event information and the matched visual template in the designated interface. For different pieces of event information, the displayed content of the terminal device varies according to the characteristics of the of event information. Therefore, the user can easily and intuitively browse user-specific event information, reducing the steps required for searching the event information, and greatly improving the user experience when obtaining event information.

### CROSS-REFERENCE TO RELATED APPLICATION

This application claims priority to Chinese Patent Application No. 201510374912.X, filed on Jun. 30, 2015, which is incorporated herein by reference in its entirety.

### TECHNICAL FIELD

Embodiments of the present invention relate to the field of computer systems, and more specifically, to displaying personalized information to a user of a computer system.

### BACKGROUND

With the development of wireless networks and information technology (e.g., the Internet), complex and varied connections have been formed between smart terminal devices (e.g., smartphones, PCs, and tablets), and internet service/content providers (ISPs) (e.g., websites). Users can use smart terminals to access content and services provided by ISPs using wireless networks.

Some functions that ISPs provide to users have become more and more intertwined with the daily life of the users. ISPs often generate information based on data related to a user's environment to display to the user. For example, a website may display weather information on a corresponding webpage or weather application to allow a user to view weather information. Some websites also display information related to holidays and special events on pages or apps to remind users of the coming holidays and events.

However, the above information provided by ISPs is generated based on the data related to the user's environment, which is generally unrelated to the personal, day-to-day life of the user. Therefore, it may be difficult for a user to obtain user-specific information using these means of displaying information.

### SUMMARY

Embodiments of the present invention describe an information display method and device for displaying user-specific information based on the user's life or environment. According to one embodiment, an information display method is disclosed, including acquiring event information corresponding to a user at a terminal device, selecting a matching visual template for the event information, and displaying the event information and the matching visual template in a designated interface of the terminal device, where the event information includes event information produced by an operation of the user, or event information produced by the terminal device based on a received communication message, and where the event information includes event characteristic information having an event type, an event time, or an event location.

According to another embodiment of the present invention, an information display device is disclosed. The device includes an acquisition module configured to acquire a plurality of event information of a user, a matching module configured to select, for each event information of the plurality of event information, a visual template that matches the respective event information, and a display module configured to display the matching event information and the visual templates in a designated interface, where the plurality of event information includes event information produced by a user-initiated operation and event information produced based on a received communication message, and the event information includes event characteristic information indicating an event type, an event time, or an event location.

### DESCRIPTION OF THE DRAWINGS

The Drawings described herein are for facilitating a better understanding of the invention and forming a part of the invention. The schematic embodiment and the description of the invention are for the purpose of further explaining the invention and do not constitute a restriction on the invention.

FIG. 1 is a flowchart illustrating an exemplary sequence of computer-implemented steps for performing a method of displaying personalized information according to embodiments of the present invention;

FIG. 2 is a block diagram of an exemplary device and interface thereof for displaying personalized event information using a visual template according to an embodiment of the present invention;

FIG. 3 is a block diagram of an exemplary device and interface thereof for displaying personalized event information using a visual template according to embodiments of the present invention;

FIG. 4a is a block diagram of an exemplary device and interface thereof for displaying personalized event information according to embodiments of the present invention;

FIG. 4b is a block diagram of an exemplary device and interface thereof for displaying specific event information in detail according to embodiments of the present invention; and

FIG. 5 is a block diagram of an exemplary device for displaying personalized event information according to embodiments of the present invention.

### DETAILED DESCRIPTION

In order to make the purpose, technical scheme, and advantages of the invention clear, the technical scheme thereof will be described clearly and completely in combination with the embodiments and corresponding figures of the invention. The described embodiments herein are exemplary.

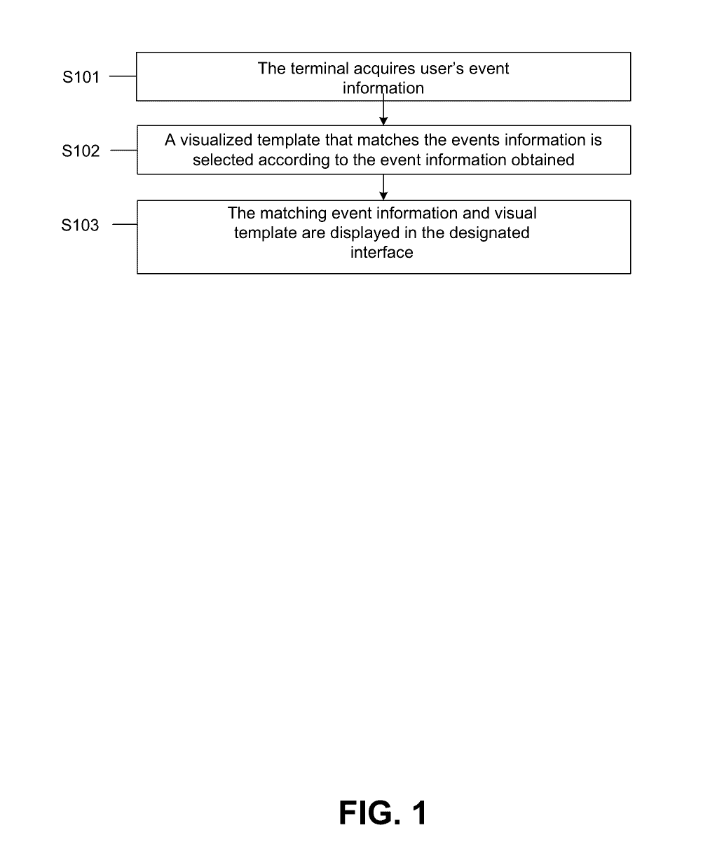

With regard to FIG. 1, a flowchart illustrating an exemplary sequence of computer-implemented steps for performing a method of displaying personalized information is depicted according to embodiments of the present invention. In S101, the terminal device acquires the user's event information. The terminal device may include, but is not limited to, a smart mobile terminal capable of displaying information, such as a smartphone, tablet computer, smart watch, a dedicated display device, and the like. The event information may include, but is not limited to, event information related to the user, such as the user's schedule, pending transactions (e.g., an airline ticket, cinema ticket, etc.) obtained through corresponding transaction operations (e.g., ordering, subscribing, or collecting operations on a website), the user's current status (e.g., the user's location and weather condition of the location), and the like.

A user can perform certain operations to generate corresponding events, such as the above mentioned transaction operations or editing operations on a terminal device (e.g., a user editing a schedule on a terminal device), and the like. The event generated from the operation often includes corresponding event information. For example, if the user inputs and/or edits their schedule on the terminal, the schedule information of the schedule that was input and/or edited can be considered event information corresponding to the user. Therefore, according to some embodiments, step S101 includes obtaining corresponding event information at the terminal device from an operation performed by the user. The event information may include information generated by a specified operation of the user.

According to some embodiments, the terminal device may be a smart mobile terminal capable of sending and receiving communication messages that may be used to generate or obtain event information. Event information of communication messages sent, generated, or received by the terminal device can be obtained. For example, if the user receives a text message containing air ticket information, the air ticket information included in the text message can be regarded as the user's event information. The communication messages may include, but are not limited to, text messages, emails, application notifications, and the like.

According to some embodiments, the terminal device includes various sensing chips or elements, such as a radio frequency identification (RFID) chip, light sensing chip, audio sensing chip, camera, and the like. Using the sensor, user event information can be obtained and used by the terminal device. According to some embodiments, step S101 includes obtaining event information using the sensors and/or communication components of the terminal device.

The methods for obtaining a user's event information are not limited to the above. For example, the terminal can make a request to a corresponding server to obtain event information stored on the server.

In S102, a visual template suitable for displaying the event information is selected based on the event information obtained. The visual template may include, but is not limited to, image templates such as static or dynamic backgrounds, skins, themes, icons, and the like. For example, the visual template may include a static photograph taken in a conference or a dynamic video of aircraft navigation. According to some embodiments, the visual template can be downloaded from the corresponding server and stored in advance by the terminal. In addition, the visual template can be stored on the server only. When a visual template needs to be selected by the terminal, it can be obtained from the server or a request can be made to the server including a selection. The visual template can be generated locally as well. For example, media can be selected from media stored locally to use as the visual template for displaying the event information. The selection can be made automatically by the terminal based on preset programs, or based on a selection input by the user. The media may include images, video, animations, and the like. For example, for the event information, “friend's birthday reminder,” a photograph of the friend can be selected to use in the corresponding visual template for the event information, and a corresponding relationship of the event information and the visual template can be established and stored locally. After the event information is generated, a corresponding visual template can be selected to display the event information, including the event information established or received by the terminal device. For example, the user may create a note or receives communication messages including event information.

The event information includes corresponding event characteristic information regarding the event type, time, and/or location for indicating the event information. In this way, the terminal device can select a visual template matching the event characteristic information of the event information. The time may relate to, but is not limited to, a reminder time, a completion time, a valid time period of the event, and the like. The space may relate to, but is not limited to, a specific place that corresponds to the event, or the user's location. For example, when the event type of the event information obtained by terminal is a conference, the terminal can select a photograph representing the conference to serve as the corresponding visual template of the event information according to the event type. The visual template may correspond to the event type of the event information, rather than the environment only (such as date and weather). In other words, abstract or generic event information can be displayed to the user intuitively in the form of images using the visual template thereof

In S103, the matched event information and visual template is displayed in the designated interface. The interface may include, but is not limited to, operating system or application interfaces, such as a desktop, menu, and the like, or inoperable interfaces, such as a screen lock interface, a startup and shutdown interface, and the like.

Using the above steps, after selecting the corresponding visual templates for different event information, the event information and the matched visual template can be displayed in the designated interface by the terminal. The content displayed by the terminal device varies based on the event information, and the visual template is displayed intuitively in the form of backgrounds, skins, icons, and/or themes. The specific event information can be displayed in the designated interface in the form of text, for example. In this way, users can browse user-specific event information conveniently and intuitively. Thus, the steps for searching event information are reduced, and the efficiency of obtaining event information is improved.

The event information may have multiple sources, including transaction operations or editing operations conducted by users at the terminal device, communication messages received by the terminal device, or a determination regarding the user's status based on data from a sensor or chip installed at the terminal. The terminal device can adopt different methods to determine or obtain event information based on the source or sources of the event information.

According to some embodiments, the event information is generated by operation of the users. The terminal device can monitor the user's operations to identify specific operations of the user. The user's event information may be obtained based on a specific operation of the user, and the terminal device may obtain specific operation information that corresponds to the specific operation to use as the user's event information. The specific operation may include a network service operation or an editing operation, for example.

In one exemplary scenario, the event information is generated through a network operation from the terminal by the users. When obtaining the network operation information corresponding to the network operation, the terminal communicates with the corresponding server. According to some embodiments of the invention, when the specific operation includes a network services operation, the method for obtaining the corresponding specific operation information to use as the user's event information includes sending a search request containing the user's identification information to a server, where the search request instructs the server to search for or identify the user's network transaction information. The terminal then receives the corresponding network transaction information of the network services operation from the server to use as the event information of the user. The network services operation may include an ordering operation, and the network transaction information may include order information or commodity information having an expiration date, for example.

For example, if the user performs an ordering operation for a commodity by visiting a corresponding commercial website or app, the ordered commodity will be sent to the user through a certain logistics service provider (such as express delivery). In this scenario, the user may be expected to pay constant attention to the ordered commodity; therefore, it can be assumed that receiving the commodity can be used as a user event. The user event in this example (receiving the delivered commodity) is an example of an event generated by an ordering operation of the user.

In another exemplary scenario, the commercial website generates order information regarding the ordered commodity. In addition to the commodity's itself, the order information also includes delivery status information, where the delivery status information of the commodity is generated and updated by the logistic service provider who is responsible for the delivery of the commodity. In this case, the terminal device can submit a query for the corresponding delivery status information based on the order information. The order information in this example is the ordering operation information, and the ordering operation information is the user's event information.

According to some embodiments, the terminal can obtain the order information from a corresponding server. For example, the terminal can send a query request to a corresponding network server to query the order record of the user from the website, and query or search for the pending order of the user using the order record. After the terminal obtains the order information, it can access the server of the delivery service provider directly, using the order information, to obtain the corresponding delivery status information of the order.

Some commodity information may already comprise event information (such as when the commodity information is a cinema ticket, airline ticket, railway ticket, and the like, which represents a user event for the user). If the user conducts an ordering operation for this kind of commodity, the commodity information will be used as the event information, and the terminal can obtain the event information from the commodity information directly.

In another example of the above method, some events of the user are generated by editing or inputting operations performed at the terminal device, such as when the user edits the corresponding event information using an editing operation of the terminal. According to some embodiments, when the specified operation includes an editing operation corresponding to the event, obtaining the specific operation information corresponding to the specific operation to use as the user's event information includes monitoring information input by the user to identify information to use as the event information of the user. The editing operation information may include information input into a schedule or note. The editing operation information may include text, pictures, audio data, and/or video data that represent the event. For example, the user may edit some events to indicate that the events are to be performed or completed at a certain time in the future using the terminal device. The editing operation information of the user may include multimedia information, such as a text, picture, audio, or video representing the events and is used as the user's event information by the terminal.

In some cases, while conducting the editing operation through the terminal, the user may not necessarily edit the event information, but may edit other information, such as a greeting text message. In most cases, the greeting text message edited by the user should not serve as the user's event information. Therefore, according to some embodiments, the monitoring of the user's editing operation by the terminal device is based on specific keywords. The terminal device will monitor the user's editing operation in a specific editing area (such as a note, notepad, memo, calendar, and the like.)

According to some embodiments, the terminal device monitors or obtains operations conducted in the terminal device by the user to generate the user's event information event. In some cases, a network service provider will generate a notification messages corresponding to a transaction operations of the user, and send the notification messages to the terminal device used by the user to confirm the purchase/transaction received from the user. For example, when a user books a flight on a certain website, the network service provider will send information corresponding to the booked flight to the terminal device used by the user (through a text messages, email, and the like) upon successful payment. When the event information includes event information from a communication messages received by the terminal device, obtaining the user's event information includes receiving the communication at the terminal device, and comparing the content of the communication message to a preset event keyword. When the content of the communication message matches the event keyword, the content of the communication message is extracted to use as the event information. The communication information may include a text message, email, or application notification, for example.

Not all communication messages received by the terminal device contain event information. According to some embodiments, the terminal device compares the content of the received communication messages with a preset keyword to determine if the communication message contains event information. The keywords can be the words representing the event type such as “conference,” “flight,” “train number,” “Super League,” and the like, or the words representing the time of the event as “kick-off time,” “activity time,” “scheduled to,” and the like. The content recognition technology can be adopted for recognizing and judging the content of the communication messages so that event information can be recognized.

For example, the terminal device can obtain a user's event information from sensor data relating to payment by card functions, authentication by card functions, human biological information monitoring/biometrics, and the like. When the event information includes event information obtained from sensing elements of the terminal device, obtaining the user's event information includes obtaining, analyzing, and/or identifying the information from the sensing elements using the terminal device to determine the user's event information. For example, when the user enters a subway station by swiping a card with a smartphone, the smartphone can obtain the user's event information using an RFID chip of the subway station.

According to some embodiments, the user can directly browse the event information obtained by the terminal device without conducting a search, and the user's event information obtained by a terminal device is stored locally in the terminal device. The terminal device will not upload or share the event information, which effectively guarantees the safety of the event information.

After obtaining the user's event information, the terminal device matches the event information with a corresponding visual template. According to some embodiments, selecting the visual template matching the event information includes determining the event characteristic information contained in the event information, and selecting the visual template matched with the obtained event characteristic information. As mentioned above, the event characteristic information contained in the event information indicates information corresponding to the event type, time, and/or location of the event information. The terminal device can determine the visual template matching the event characteristic information according to the characteristics of the event type, time, and location indicated in the event characteristic information.

Selecting the visual template matching the event characteristic information does not necessarily mean that the characteristics in the event characteristic information are identical to that of the visual template. According to some embodiments, if the characteristics types of the event characteristic information are identical to that of the visual template, it is can be treated as a match. For example, when the characteristics type of the event characteristic information of the event information obtained by the terminal device is “flight,” and the visual templates for the characteristic is “flight background,” although the characteristics in the event characteristic information are not identical to that of the visual template, the two characteristics are both related to airline flight. Therefore, the terminal device will match the event characteristic information with the visual template, and the visual template with the characteristic of “plane background” will be regarded as the visual template of the event information by the terminal device.

If the visual template can be stored locally in the terminal device, the matching process may include the terminal device locally matching the event information and the visual template. If the visual template is stored on the server side, the terminal device interacts with the server side to complete the matching process for the event information and the visual template.

According to some embodiments, the terminal device sends a matching request including the event characteristic information to the server so that the server will select the visual template corresponding to the event characteristic information. The terminal device then receives the corresponding visual template of the event characteristic information from the server to use as the visual template matched with the event information; alternatively, the terminal device stores the visual template, where the visual template can be downloaded from the server or generated in the terminal device locally. The terminal device selects the visual template matching the event characteristic information in the visual templates stored locally according to the event characteristic information to use as the visual template of the event information.

The matching process for the event information and visual template enables the terminal device to display the matched event information and corresponding visual template in the interface specified by the terminal device. The process and method for displaying the event information and the visual template by the terminal device are described specifically as follows. According to some embodiments of the invention, the terminal device is capable of displaying the event information and the matched visual template in multiple interfaces of the terminal device. Specifically, the designated interface may include an operable interface and inoperable interface. The operable interface includes the interface that can be operated by users. The operable interface can provide a response to user operation, where the user operation may include a touching operation, clicking operation, voice operation, and inputting operation using a hardware button. For example, the operable interface may include the terminal device desktop or menu interfaces. The inoperable interface may include the terminal device screen lock interfaces and startup and shutdown interfaces.

For a user indicating the location information of the event information using the event feature information, the matching event information and visual template are displayed in the designated interface. Specifically, the location information corresponding to the event information is determined by the terminal device, the visual template matching the location information is selected accordingly, and the visual template is displayed in the operable interface and/or inoperable interface. For example, the user's event information may indicate that the user will go to City B from City A. The terminal device can put the visual templates of City A and City B (e.g., pictures of a night scene of the two cities) together as a background picture. The background picture is displayed on the desktop of the terminal device to prompt or remind the user.

According to some embodiments, the event information has both a spatial feature and timeliness value. The timeliness value of event information generally indicates time information corresponding to the event information, and more specifically, the time information reflects that the event information is effective during the corresponding period of time. The location information of the event information reflects spatial features of the event information.

For example, when the user's event information includes flight information, time information, such as the departure time and the arrival time, is typically included. Therefore, it can be assumed that the event information including flight information is effective during the period of time from the departure time to the arrival time. Meanwhile, the flight information typically includes location information, such as the place of departure and the destination, so it can be assumed that the flight information is effective between the two places. In this way, the display of the event information by the terminal device may be based on the time information and location information of the event information.

In some cases, the user's event information determined by the terminal device may have a multiple events with different time information in chronological order. The occurrence of events varies in terms of time sequence, and the event information with a time sequence closest to the current moment is preferably displayed. According to some embodiments, in order to display the user's event information clearly and visually, the event information is displayed with a visual templates that matches the time information included in different event information (e.g., displayed according to the time sequence of the time information).

According to some embodiments, when the event feature information is used for indicating time information of the event information, the matched event information and visual template are displayed in the designated interface. Specifically, the time information of the event information is determined by the terminal device, the event information is displayed with each matched visual template in the operable interface ordered in a time sequence corresponding to the time information (e.g., chronological or reverse chronological order). Specifically, the terminal device determines the time information of the event information based on acquired event information. For example, when the terminal device receives a short message or notification containing flight information, the terminal can acquire the user's relevant flight information from the short message or notification. Also, when the flight information sent to the terminal device includes time information such as the departure time and the arrival time of the flight, based on the flight information, the terminal device can determine the time information included in the flight information.

Generally, for time information of event information, the terminal device displays the event information and its corresponding visual template in a corresponding time sequence. In this way, the user can browse the coming event and the future follow-up events.

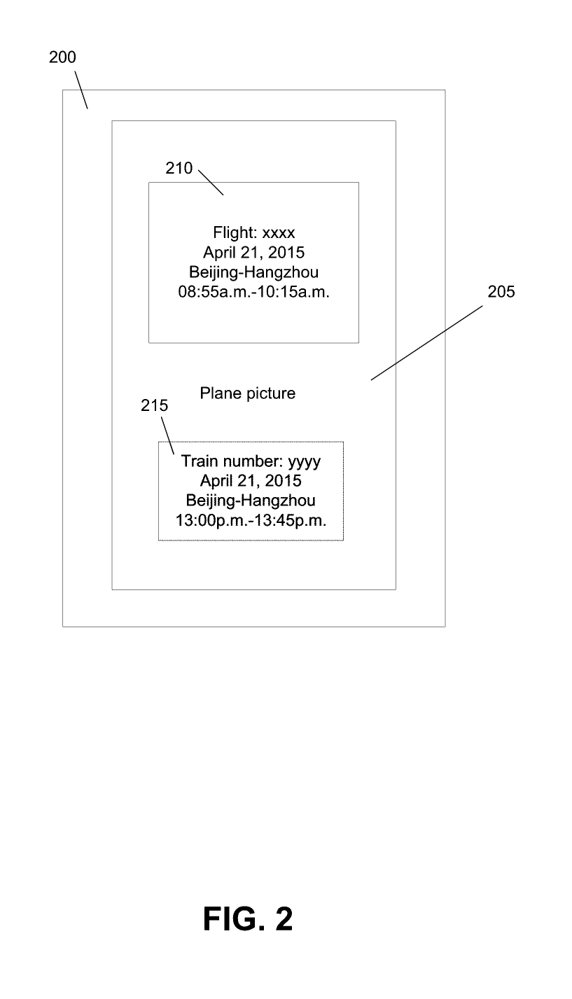

With regard to FIG. 2, a block diagram of an exemplary device for displaying personalized event information using visual templates is depicted according to embodiments of the present invention. The terminal device 200 is a mobile phone that acquires two pieces of event information, including the user's flight information 210 and train information 215. The flight information 210 includes a flight from 8:55 a.m. to 10:15 a.m. on Tuesday, Apr. 21, 2015, from Beijing to Hangzhou, and the train information 215 includes a trip from 13:00 pm to 13:45 pm on Tuesday, Apr. 21, 2015 from Hangzhou to Shanghai. The mobile phone 200 selects the pre-stored visual templates by matching the acquired flight information and train information.

For example, when the mobile phone 200 selects a picture for a plane based on the flight information 210 as its visual template, a dynamic picture of a running train is selected based on the train information 215 as the visual template. In this way, the flight information and the train information will be displayed on the desktop 205 of the mobile phone 200 in an ordered time sequence. When the current time is 8:40 a.m. on Apr. 21, 2015, for example, the flight information 210 is more relevant. It can be assumed that this event has the highest priority among the events. Therefore, the content of the flight information 210 will be displayed on the desktop 205 of the mobile phone 200, and the current background picture on the desktop 205 of the mobile phone 200 will change to a visual template matching the flight information 210. The time priority of train information is lower than that of the flight information. Therefore, the mobile phone does not highlight the train information, or displays effects such as fuzziness, fading, and translucency, for example, or the visual template is not displayed.

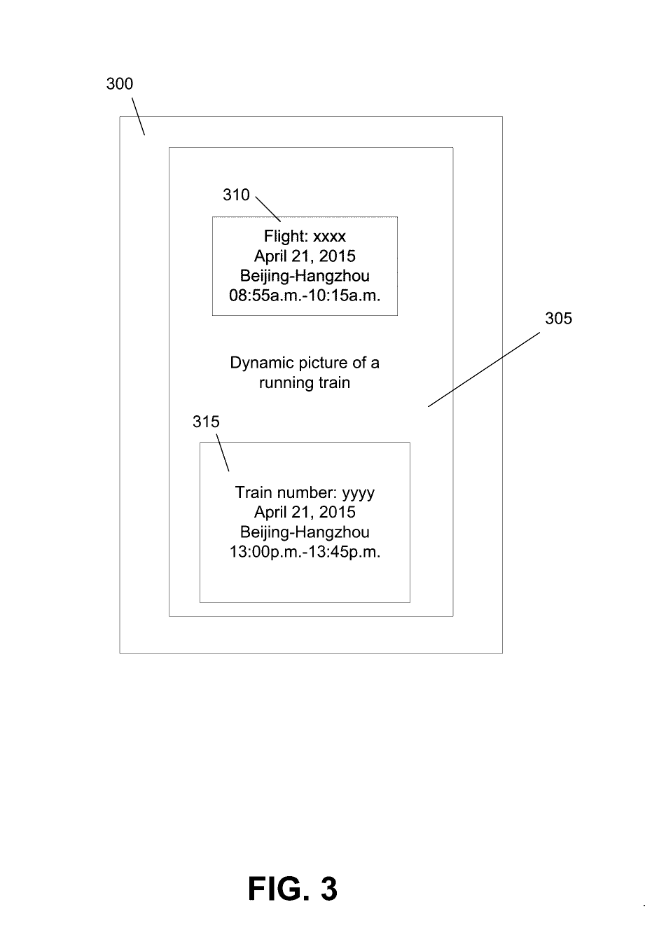

With regard to FIG. 3, a block diagram of an exemplary device for displaying detailed personalized event information using a visual template is depicted according to embodiments of the present invention. The user takes the flight to the destination, and the current time changes to 12:50 a.m. on Apr. 21, 2015. When the train information is coming into effect, the content of train information 315 will be displayed on the desktop 305 of the display device 300, and the current background picture on the desktop 305 of the display device 300 will change into a visual template matching the train information (e.g., a dynamic picture for a running train).

As mentioned, the terminal device displays the user's personalized event information based on a time value or range for the event information after it acquires the user's event information, and it will automatically change to display the relevant event information based on the time information. The display mode can save the user a significantly amount of time when searching for the event information.

The event information (e.g., the flight information and the train information) can be shown on the visual template using an embedded display. The time span between the occurrence of the event information and the moment when the event and its visual template are displayed by the terminal device can be preset. For example, the terminal device can be configured to display the event information two hours in advance of the event. In the above example, the relevant time of the flight information is 8:55 a.m., and the mobile phone displays the flight information and its visual template on its desktop beginning at 6:55 a.m. The relevant time of the train information is 13:00 pm, and the mobile phone displays the train information and a visual picture on the desktop starting at 11:00 a.m. The time spans can be set and adjusted as necessary.

If the flight information is expired, and the mobile phone has not deleted the expired flight information, in some cases, the user may want to look up some expired event information. According to some embodiments, the terminal device will display the expired event information and its matching visual template in sequence. Specifically, the terminal device displays the event information with expired time information and effective time information in the interface based on the corresponding time sequences. The terminal device can mark the expired event information by dimming, making the information grayscale, and marking with a specific color.

In some cases, the user's event information may include several different events, and the terminal device may acquire multiple pieces of the user's event information, where the durations of different time information may be relatively long. For the user's convenience, according to some embodiments, when the designated interface includes an operable interface, the method includes receiving the operation command for the event information displayed in the operable interface, and displaying the event information corresponding to the operation command and its corresponding visual template in the operable interface. The operation command may include a “Click” command or a “Slide” command. The user can perform “Click” and “Slide” operations for the displayed event information to conveniently browse previous event information and new event information.

When the user performs a slide operation on the event information in the operable interface, the event information may be moved to the designated position in the operable interface, and the next event information in the “Slide” order, and the corresponding visual template, will be displayed in the current operable interface. The event information may be moved to another operable interface using a sliding operation (e.g., sliding, swiping, or moving the event information to another form or page) or a page turning operation on the event information. In this way, the event information and its corresponding visual template will be displayed in the other operable interface.

Event information with time information can be used to form a “time base” display mode for the user to browse and inquire, effectively increasing the user's efficiency when acquiring event information.

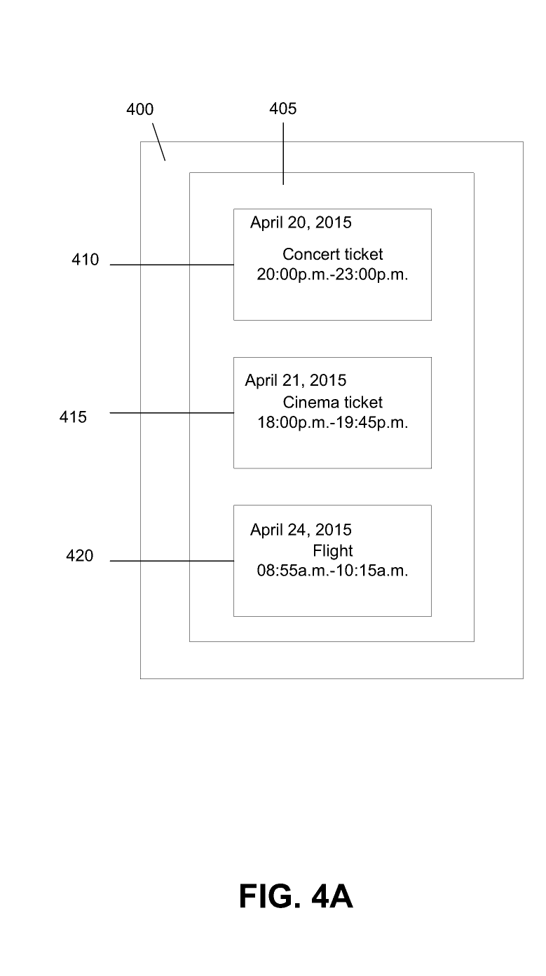

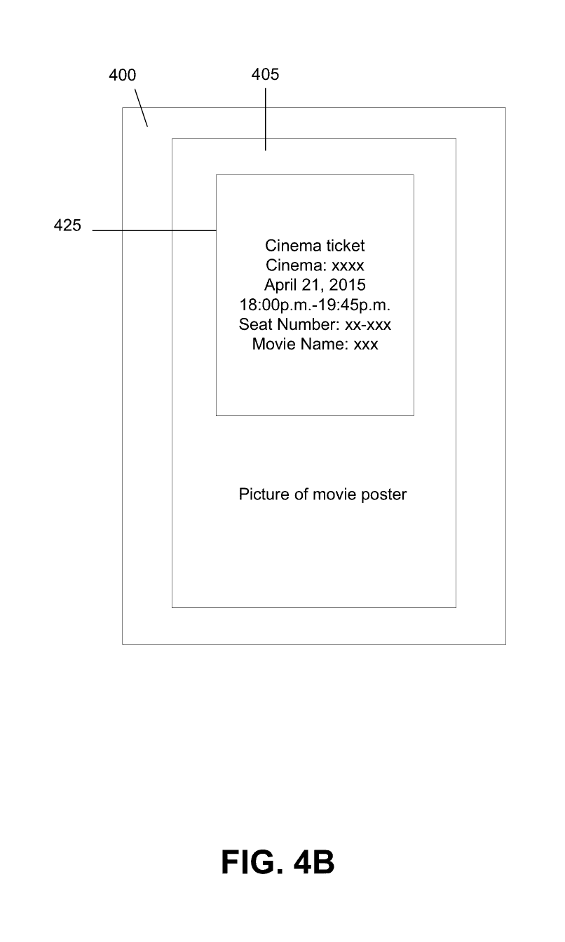

With regard to FIG. 4a, a block diagram of an exemplary display device 400 for displaying personalized event information is depicted according to embodiments of the present invention. The mobile phone displays three pieces of the user's event information and corresponding dates, where the event information includes a concert ticket 410 for Apr. 20, 2015, that has expired and is used as a record of the user's event. The event information is displayed on the desktop 405 of the mobile phone 400 in the form of abbreviated information. At this moment, the user has not performed a “Click” operation on any one of the event information, therefore, no visual template will necessarily be displayed on the desktop 405 of the mobile phone 400 (although a preset default templates may be displayed). Clearly, for FIG. 4a, the user may perform a “Slide” operation on the interface to browse more event information.

With regard to FIG. 4b, a block diagram of an exemplary display device 400 for displaying a specific item of personalized event information is depicted according to embodiments of the present invention. When the user clicks the cinema ticket 415, the interface of the display device 400 changes to the interface shown in FIG. 4b, where the mobile phone 400 displays the detailed event information 425. When the visual template matching the event information is a movie poster, for example, the mobile phone will display a picture of the movie poster on the desktop 405 after the user clicks the event information. The event information can be displayed in a floating window or layered based on the interface shown in FIG. 4a, or the event information can also be displayed individually, as depicted in FIG. 4b. Similarly, the mobile phone will also display other event information and the associated visual template selected by the users after the user clicks on other event information in FIG. 4a. If the user does not click on or browse the event information displayed in FIG. 4a, the mobile phone will automatically display details of event information based on the time span between the current time and the effective time of the event information.

In some cases, the terminal device may be in a locked state (e.g., displaying a lock screen interface) or an on/off state (e.g., startup or shutdown screen). According to some embodiments, the terminal device can display the event information in an inoperable interface. Specifically, when a designated interface includes an inoperable interface, and the event feature information is used for indicating time information of the event information, the terminal device displays the matching event information and visual template in the designated interface. The terminal device determines the time information of the event information, selects the time information closest to the current moment based on the determined time information, and displays the event information containing the time information and its visual template in the inoperable interface.

When the inoperable interface includes a lock screen interface of the terminal device, if the terminal device acquires multiple pieces of the user's event information that have not yet come into effect (or become relevant to the user), the terminal device will only select and display the event information closest to the current time in the lock screen interface. However, because static or dynamic wallpapers can generally be displayed in the lock screen interface, the terminal device will also display the visual template matching the event information in the lock screen interface. When the inoperable interface includes an on/off interface, the interface of the terminal device will generally display no wallpaper. Therefore, the terminal device will only display certain upcoming event information in the on/off interface.

The terminal device can display the user's event information and corresponding visual template in multiple interfaces. In this way, a user can acquire their event information visually. The terminal device can also acquire, in real-time, location information of the user and acquire weather information from a corresponding server based on the acquired location information. The terminal device can display the location information and its corresponding weather information in combination with the user's event information. For example, if the terminal device acquires the user's flight information, where the flight flies from City A to City B, the terminal device will also acquire the user's current location information (the user is in City A before departure), and further acquire the weather information in current City A. The terminal device forms the visual template of City A and its weather information at the current moment in combination with the visual template of flight information (e.g., an editable flight picture); the template displayed by the terminal device can be a flight picture representing a geographical location and weather information. Similarly, after the user arrives in City B, the terminal device can also acquire the location information of City B and further acquire and display the weather information of City B. The terminal device can also acquire information such as the season, holidays, and festivals, form a dynamic visual template in combination with the location and weather information, and display the dynamic visual template with the corresponding event information.

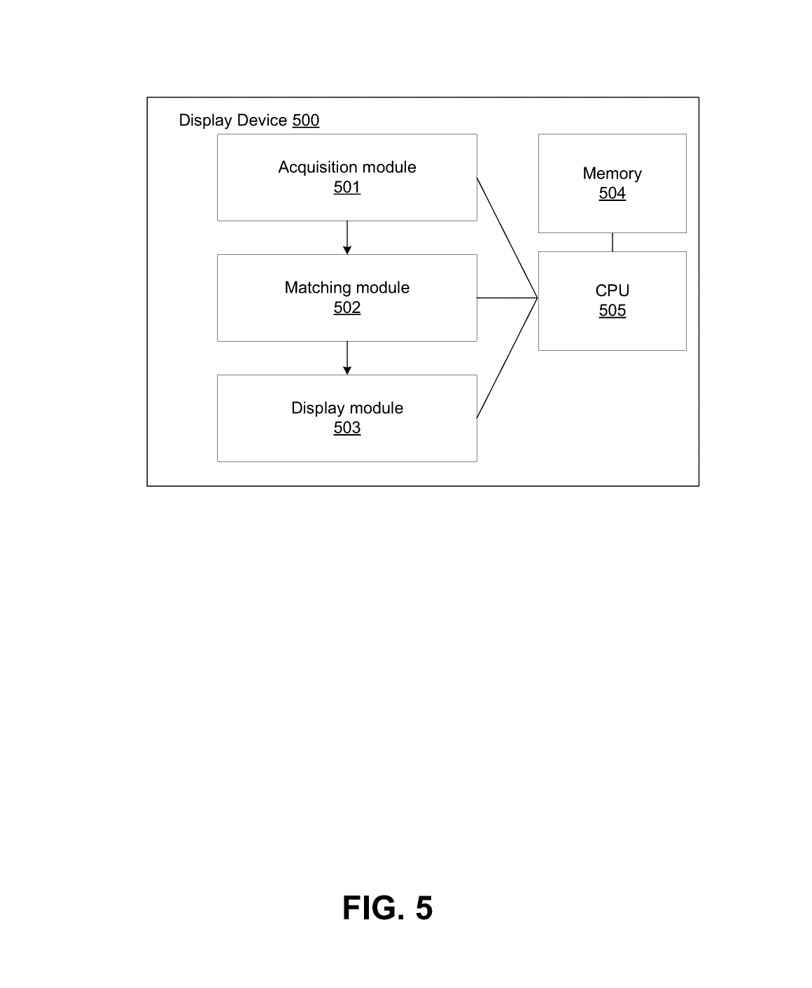

With regard to FIG. 5, an information display device 500 is depicted according to embodiments of the present invention. The information display device 500 includes acquisition module 501, matching module 502, display module 503, memory 504, and CPU 505. Acquisition module 501 acquires the user's event information. Matching module 502 selects the visual template matching the acquired event information. Display module 503 displays the matching event information and visual template in the designated interface. CPU 505 processes data and stores data using memory 504. Memory 504 may phase change memory (PRAM), static random-access memory (SRAM), dynamic random-access memory (DRAM), other types of random-access memory (RAM), read-only memory (ROM), electrically erasable programmable read-only memory (EEPROM), flash memory or other internal memory technology, compact disk read-only memory (CD-ROM), digital versatile disc (DVD) or other optical storage, tape and cassette tape, magnetic tape or disk storage (e.g., a hard disk drive or solid state drive), or other magnetic storage device. CPU 505 communicates with acquisition module 501, matching module 502, and/or display module 503 for processing data when generating and displaying event information, for example.

The event information may include the event information produced by user-initiated operations and/or event information produced by the terminal device based on received communication information (e.g., text messages and emails). The event information also may include event feature information used for indicating the event type, time, and/or location corresponding to the event information.

According to some embodiments, when the event information includes event information produced by a user initiated operation, acquisition module 501 monitors the user initiated operation by the terminal device, and acquires initiated operation information corresponding to the initiated operation to be used as the user's event information.

According to some embodiments, an initiated operation includes a network services operation and/or an event editing operation. When the initiated operation includes a network services operation, acquisition module 501 sends a query request containing the user's identification information to the server to query for the user's network services information, receives feedback from the server regarding the network services information corresponding to the network services operation, and uses the network services information as the user's event information. When the network services operation includes placing an order, the network services information includes order information and/or commodity information containing an expiration date.

When the initiated operation includes an event editing operation, acquisition module 501 monitors the editing information input by the user and uses the editing information as the user's event information. The editing information is used to change or enter information in a schedule, calendar, or note, for example. The editing information may include text, a picture, audio data, and/or video data for characterizing events.

According to some embodiments, when the event information includes event information produced by the terminal device based on the received communication information, acquisition module 501 receives the communication information and compares/matches the contents of the received communication to preset event keywords. When the content of the communication information matches one or more event keywords, the acquisition module 501 extracts the matching keywords as the event information. According to some embodiments, the communication information includes a short message, email, and/or application notification.

Matching module 502 determines event feature information included in the event information and selects the visual template matching the event feature information. Matching module 502 also sends a matching request including the event feature information to the server to identify the visual template corresponding to the event feature information, receives feedback from the server regarding the visual template corresponding to the event feature information, and uses the corresponding visual template as the visual template matching the event information. Alternatively, matching module 502 may pre-store a visual template in the local terminal device, and, based on the event feature information, select the visual template matching the event feature information in the pre-stored visual template as the visual template of the event information.

According to some embodiments, the visual template includes a static or dynamic image template for backgrounds, skins, themes, or icons, and the designated interface includes an operable interface and/or an inoperable interface. The operable interface includes at least one desktop and menu interface of the terminal device, and the inoperable interface includes at least one lock screen interface and an on/off interface of the terminal device.

When the event feature information is used for indicating location information of the event information, display module 503 determines the location information corresponding to the event information, selects a visual template matching the location information, and displays the visual template in the operable interface and/or inoperable interface.

When the designated interface includes an operable interface, and the event feature information is used for indicating time information of the event information, display module 503 determines the time information of the event information based on the time sequence corresponding to the time information, and displays the event information and the matching visual template in the operable interface in sequence. In addition, display module 503 displays expired event information and effective/relevant event information in the designated interface in the time sequence based on the time information.

When the designated interface includes an operable interface, display module 503 receives an operation command for event information displayed in the operable interface, and displays event information corresponding to the operation command, and the corresponding visual template, in the operable interface or another interface. The operation command may include a click command and/or a slide command, for example.

When the designated interface includes an inoperable interface, display module 503 determines time information from the event information, selects the time information having the shortest time between the current time based and the determined time information, and displays the event information including the time information and the matching visual template in the inoperable interface.

In a typical configuration, a computing device includes one or more processors (CPU), input/output ports, network ports, and memory. The memory may include volatile memory, random-access memory (RAM), and/or non-volatile internal memory of the computer-readable media, such as the read-only memory (ROM), or flash memory (flash RAM). The memory is an example of the computer-readable media.

The computer-readable media include permanent medium and non-permanent medium, movable and immovable medium, and can realize information storage by any mode or technology. The information can be a computer-readable command, data structure, program module, or other data. The examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other internal memory technology, compact disk read-only memory (CD-ROM), digital versatile disc (DVD) or other optical storage, tape and cassette tape, magnetic tape or disk storage, or other magnetic storage device or any other non-transmission media which can be used for storing the information that can be accessed by the computing device. As defined in this article, the computer-readable media do not include transitory computer-readable media (transitory media), such as the modulation data signal and carrier wave.

It should also be noted that the terms “include,” “contain,” or any other variants are intended to cover the non-exclusive “containing” which makes the processes, methods, commodities, or devices having a series of elements include not only those elements, but also other elements not clearly set out, or the inherent elements of these processes, methods, commodities or devices. When there is no any further specification, the element specified by the sentence “including one . . . ” does not rule out that there are other identical elements in the processes, methods, commodities, or devices including the elements.

A person skilled in the art shall understand that an embodiment of the invention can be provided as a method, a system, or a computer program product. Therefore, the invention can adopt a form of a full hardware embodiment, full software embodiment, or embodiments combining software with hardware. Furthermore, the invention can also adopt a form of computer program products implemented on one or more computer-readable storage media (including, but not limited to, magnetic disk memory, CD-ROM, and optical memory) containing computer-readable program codes.

What has been discussed above are only embodiments of the invention, which are not intended to limit the invention. For a person skilled in the art, various alterations and changes can be made to the invention and any modification, equivalent replacement, and improvement made within the spirit and principle of the invention shall fall into the scope of the Claims of the invention.

What is claimed is:

1. A method for displaying event information, the method comprising:
acquiring event information corresponding to a user at a terminal device;
selecting a matching visual template for the event information; and
displaying the event information and the matching visual template in a designated interface of the terminal device, wherein the event information comprises at least one of: event information produced by a user-initiated operation, and event information produced by the terminal device based on a received communication message,
and wherein the event information comprises event characteristic information comprising at least one of: an event type, an event time, and an event location.

2. The method of claim 1, wherein the acquiring event information corresponding to a user at a terminal device further comprises:
monitoring the activity of the user at the terminal device to identify the user-initiated operation;
acquiring operation information corresponding to the user-initiated operation; and
displaying the operation information as event information in the designated interface.

3. The method of claim 2, wherein the user-initiated operation comprises a network services operation, and the acquiring operation information corresponding to the user-initiated operation further comprises:
sending a query request comprising user identification information of the user to a server using the terminal device; and
receiving the network service information from the server in response to the query request, wherein the network services information is displayed as event information by the terminal device.

4. The method of claim 3, wherein the network services operation comprises placing an order, and the network service information comprises at least one of: order information and commodity information comprising an expiration date.

5. The method of claim 4, wherein the user-initiated operation comprises an editing operation, and the acquiring operation information corresponding to the user-initiated operation comprises:
monitoring the editing operation to identify edition operation information input by the user at the terminal device; and
using the editing operation information as the user's event information.

6. The method of claim 5, wherein the editing operation information is based on at least one of: a schedule application entry entered by the user and a note application entry entered by the user, and the editing operation information comprises at least one of: text, a picture, audio information, and video information.

7. The method of claim 1, wherein the event information comprises the received communication message, and the acquiring event information corresponding to a user at a terminal device comprises:
receiving the communication information at the terminal device;
comparing content of the communication information with preset event keywords to identify matching keywords; and
extracting content of the communication information to use as the event information when the content of the communication information comprises matching keywords.

8. The method of claim 7, wherein the communication information comprises at least one of: a short message, an email, and an application notification.

9. The method of claim 1, wherein the selecting a visual template for the event information further comprises:
determining characteristic information from the event information; and
selecting the matching visual template for the characteristic information of the event based on the characteristic information.

10. The method of claim 9, wherein the selecting the matching visual template for the characteristic information of the event based on the characteristic information further comprises:
sending a request comprising the characteristic information to a server;
receiving the matching visual template from the server; and
using the matching visual template for the event information.

11. The method of claim 1, wherein the matching visual template comprises an image template comprising at least one of: a static background, a dynamic background, a skin, a theme, and an icon, and the designated interface comprises at least one of: an operable interface and an inoperable interface.

12. The method of claim 11, wherein the operable interface comprises at least one of: a desktop of the terminal device and a menu of the terminal device, and the inoperable interface comprises at least one of: a lock screen interface of the terminal device and on/off interface of the terminal device.

13. The method of claim 11, wherein when the event characteristic information comprises event location information indicating a location associated with the event, and the displaying the event information and the matching visual template in a designated interface of the terminal device further comprises:
determining the location information corresponding to the event information;
selecting a first visual template associated with the location information; and
displaying the visual template in at least one of: the operable interface and the inoperable interface.

14. The method of claim 11, wherein when the designated interface comprises the operable interface, the event information comprises time information associated with the event, and the displaying the event information and the matching visual template in a designated interface of the terminal device further comprises:
determining the time information of the event information; and
displaying the event information and the matching visual template in the operable interface, wherein a display order of the event information is based on the time information of the event information.

15. The method of claim 14, wherein the displaying the event information and the matching visual template in the operable interface further comprises displaying event information comprising expired time information and unexpired event information in the designated interface, and wherein the event information is displayed in an order based on the time information.

16. The method of claim 11, further comprising:
receiving an operation command for the event information displayed on the operable interface at the terminal device; and
displaying a first event information corresponding to the operation command, and a first visual template corresponding to the first event information, in the operable interface.

17. The method of claim 12, wherein the matching event information and the displaying the event information and the matching visual template in a designated interface of the terminal device further comprises:
determining a first event time for the event information;
determining a second event time for a second event information; and
displaying the event information and the matching visual template in the inoperable interface when a first time period between the event time and a current time is shorter than a second time period between the second event time and the current time.

18. An information display device, comprising:
an acquisition module configured to acquire a plurality of event information of a user;
a matching module configured to select, for each event information of the plurality of event information, a visual template that matches the respective event information; and
a display module configured to display the matching event information and the visual templates in a designated interface,
wherein the plurality of event information comprises event information produced by the a user-initiated operation and event information produced based on a received communication message, and the event information comprises event characteristic information indicating at least one of: an event type, an event time, and an event location.

19. The device of claim 18, wherein the terminal device monitors activities of the user to identify a first user-initiated operation, and the acquisition module acquires user-initiated operation information of the first user-initiated operation to be used as the event information of the user.

20. An information display device, comprising:
at least one processor; and
at least one computer-readable storage device comprising instructions that when executed cause performance of a method for displaying event information, the method comprising:
selecting a matching visual template for the event information; and
displaying the event information and the matching visual template in a designated interface of the display device, wherein the event information comprises at least one of: event information produced by a user-initiated operation, and event information produced by the terminal device based on a received communication message,
and wherein the event information comprises event characteristic information comprising at least one of: an event type, an event time, and an event location.
